(19) United States
(12) Patent Application Publication
(10) Pub. No.: US 2019/0276984 A1
(43) Pub. Date: Sep. 12, 2019

(54) SYSTEMS AND METHODS FOR VARIABLE SHOWER WATER JET IMPINGEMENT FOR FABRIC CONDITIONING

(71) Applicant: Kadant Inc., Westford, MA (US)

(72) Inventor: Peter Thuroe CARSTENSEN, Adirondack, NY (US)

(21) Appl. No.: 16/295,837

(22) Filed: Mar. 7, 2019

Related U.S. Application Data
(60) Provisional application No. 62/639,765, filed on Mar. 7, 2018.

(51) Int. Cl. D21F 1/32; B05B 1/02; D21F 7/08; D21G 9/00; D21F 1/52

(52) U.S. Cl. CPC D21F 1/32; B05B 1/02; D21F 1/52; D21G 9/0009; D21F 7/08

(57) ABSTRACT

A system is disclosed for providing impingement of a fluid for fabric conditioning. The system includes a fluid jet and a control mechanism for adjusting an impingement angle of the fluid jet onto a workpiece such that the angle may be adjusted through an angle that is perpendicular to the workpiece.

### PRIORITY

The present application claims priority to U.S. Provisional Patent Application Ser. No. 62/639,765 filed Mar. 7, 2018, the disclosure of which is hereby incorporated by reference in its entirety.

### BACKGROUND

The invention generally relates to paper marking systems and processes, and relates in particular to conveying systems for conveying material in paper making systems.

In the paper making process the paper sheet is conveyed through the paper machine by a multitude of belts known as wires in the forming section, belts in the pressing section and dryer fabrics in the dryer section (for sake of simplicity, belts will refer to all conveying fabrics regardless of paper machine position). Each of the belts is chosen based upon relevant corresponding design specifications, such as surface characteristics, open area, void volume, permeability, smoothness, etc., to achieve specific goals in the papermaking process. During use, one or more of the design specifications of the fabrics may be affected by a build-up of contaminants released from the paper furnish or otherwise introduced to the system. This build up can lead to production inefficiencies, lower paper quality, and increased costs.

Removal of the contaminates is necessary to maintain peak efficiency of the paper manufacturing process and the quality of the resultant paper product. Decreased efficiency due to contamination can translate into slower throughput speed of the system to achieve the same results, downtime to replace underperforming belts, adjustments to address paper quality issues such as textured surfaces or impurities in the paper, sheet stealing (the paper web travels with the belt at transfer points instead of transferring to the next belted section), lower moisture extraction efficiency, and increased labor and overhead to produce the same amount of product.

To maintain acceptable efficiency, a series of showers are utilized to remove the contaminates from the conveying belts, maintain the void volume and caliper, and to provide uniform drying. The shower(s) are of various configurations and operating pressures, temperatures and flows. A primary application of most showers is to force contaminates through (penetration) the belts or skive contaminates off (reversion) the surface of the belts. In either of these two cases noted, the shower is delivering a water stream that is forcing contaminates from the conveying belts.

There remains a need however, for a more efficient and economical system and process for the removal of contaminates in paper making processes.

### SUMMARY

In accordance with an embodiment, the invention provides a system for providing impingement of a fluid for fabric conditioning. The system includes a fluid jet and a control mechanism for adjusting an impingement angle of the fluid jet onto a workpiece such that the angle may be adjusted through an angle that is perpendicular to the workpiece.

In accordance with another embodiment, the invention provides a method of removing contaminants from a papermaking belt used for making a paper sheet. The method includes the steps of: feeding the belt in a first direction, spraying the belt with a cleaning fluid directed at a first cleaning angle with respect to the belt, monitoring performance characteristics of the belt, and changing the cleaning angle from the first cleaning angle to a second cleaning angle responsive to the monitored performance characteristics.

In accordance with a further embodiment, the invention provides an apparatus for cleaning a papermaking belt traveling through a papermaking system at a travel velocity. The apparatus includes an elongated shower pipe having at least one nozzle, a supply conduit for providing a cleaning fluid to said at least one nozzle, a first adjustment means coupled to said shower pipe for rotating said at least one nozzle about a first axis, and monitoring means for monitoring performance characteristics of the belt.

### BRIEF DESCRIPTION OF THE DRAWINGS

The following description may be further understood with reference to the accompanying drawings in which:

FIG. 1 shows an illustrative diagrammatic front view of a typical shower pipe with nozzles attached;

FIG. 2 shows an illustrative diagrammatic perspective view of a system in accordance with an embodiment of the present invention;

FIGS. 3A and 3B show illustrative diagrammatic views of a portion of a paper making system employing an embodiment of the invention in chiseling (FIG. 3A) and chasing (FIG. 3B) positions;

FIGS. 4A and 4B show illustrative diagrammatic views of various force and velocity associates with the views of FIGS. 3A and 3B;

FIGS. 5A and 5B show illustrative diagrammatic exaggerated close-up views of different angles in chiseling (FIG. 5A) and chasing (FIG. 5B) positions acting on a paper making belt;

FIG. 6 shows an illustrative graphical representation of a periodic cycle of different cleaning strategies;

FIGS. 7A and 7B show illustrative diagrammatic views of a portion of a paper making system employing another embodiment of the invention in chiseling (FIG. 7A) and chasing (FIG. 7B) positions, with a constant distance to a vacuum box;

FIG. 8 shows an illustrative diagrammatic isometric view of an embodiment of the present invention in a central position;

FIG. 9 shows an illustrative diagrammatic isometric view of an embodiment of the present invention in a forward position;

FIG. 10 shows an illustrative isometric view of a close-up of an adjustable shower pipe assembly according to an embodiment of the invention shown in FIGS. 8 and 9;

FIG. 11 shows an illustrative diagrammatic partially exploded isometric view of the adjustable shower pipe assembly of FIG. 10;

FIG. 12 shows an illustrative diagrammatic isometric view of an automated internal angle adjustment structure of an adjustable shower pipe assembly according to a further embodiment of the invention;

FIG. 13 shows an illustrative diagrammatic isometric view of an embodiment of the present invention employing the adjustment structure of FIG. 12 in a central position;

FIG. 14 shows an illustrative partially cut-away side view of the embodiment of the invention shown in FIG. 13;

FIGS. 15 and 16 show illustrative diagrammatic side views of gear assemblies of embodiments of the invention that allow for rotational and translational movement of an adjustable shower pipe assembly; and

FIG. 17 shows an illustrative diagrammatic view of a monitoring system according to an embodiment of the invention.

The drawings are shown for illustrative purposes only.

### DETAILED DESCRIPTION

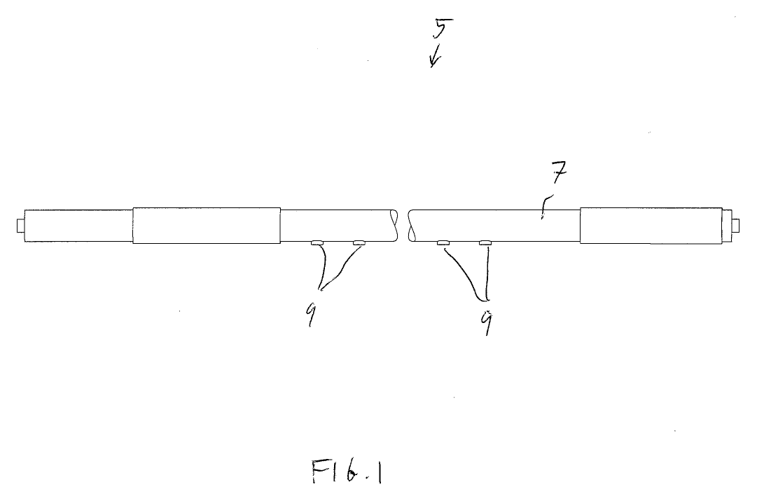

In accordance with various embodiments of the present invention, the geometric layout of the shower/belt interaction is configured in such a manner as to provide the most efficient hydro/mechanical force vector interaction angle(s) that will provide the desired continuous contaminate removal function to the targeted belt. FIG. 1 shows at 5 a typical shower beam (pipe) 7 with water jets 9 attached.

In the case of a belt that has intra-matrices or filament covered surfaces of either woven or needled design, a contamination memory of sorts (age related contamination buildup) develops over time that is the result of the conditioning application that is in a fixed static geometric arrangement.

In accordance with certain embodiments, the invention provides a system and method with the ability to change the jet impingement hydro/mechanical force vector angle on the fly without disruption to other paper manufacturing processes. This allows an applied energy variation of the jet impingement angle, which allows removal of older built up contamination herein called contamination memory. This change in conditioning energy applied geometry, breaks the contamination memory that is aged developed, reviving dewatering efficiency of the targeted fabric thus minimizing paper machine production slowdown or down time for (either); fabric belt replacement, chemical cleaning over drying of the paper sheet to be produced. The shower(s) may be of various configurations and operating pressures, temperatures and flows.

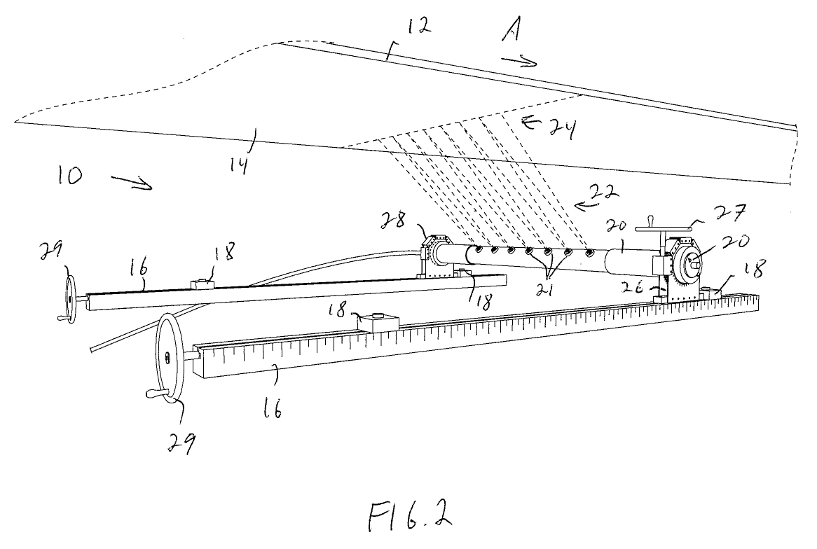

FIG. 2 for example, shows a system 10 in accordance with an embodiment of the invention that may be used to remove contaminates from a conveying belt 12 in a papermaking system. The system 10 sprays a cleaning fluid (e.g., water) to an underside 14 of the conveying belt 12 as the conveying belt moves in a direction as generally shown at A. In particular, the system 10 includes a shower beam 20 that is mounted in beam mounts 26, 28, each of which rides along beam rails 16. The shower beam includes nozzles 21 that provide the cleaning fluid in spray jets 22 that impinge the belt 12 in a cleaning area 24. The shower beam 20 may be rotated within the beam mounts 26, 28 via actuation of a beam actuator 27, and the beam mounts may be movable along the beam rails 18 (between stops 18) by rail actuators 29.

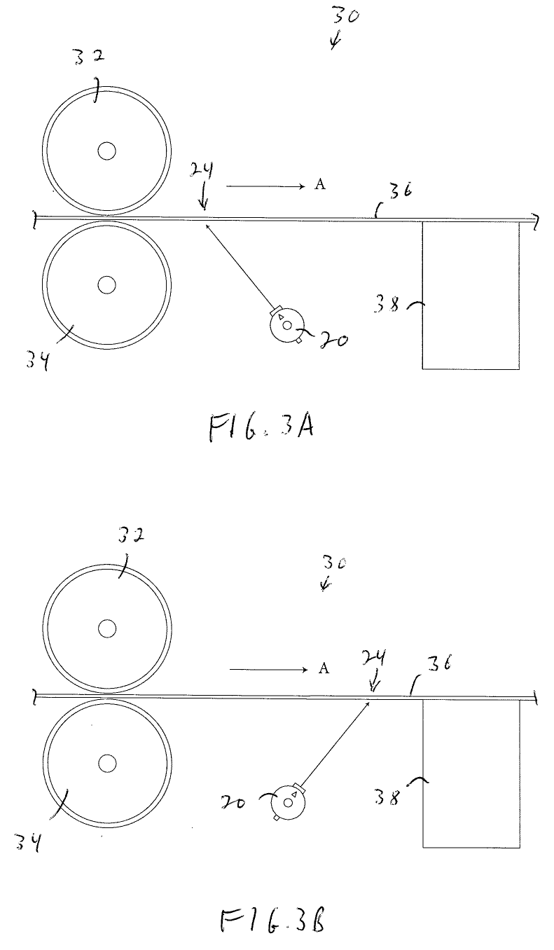

Fabric cleaning may take place at various locations throughout the paper making system. FIGS. 3A and 3B show an example of a cleaning arrangement 30 where a shower beam 20 is disposed between a nip roller set of upper drum 32 and lower drum 34, and a vacuum box 38. In this example, a belt 36 undergoes a first dewatering step as it is pressed between upper and lower rollers 32/34. The shower beam 20 then directs a jet of cleaning fluid 22 at the belt 36 to flush contaminants therefrom. The belt then moves over a vacuum box 38 where additional dewatering of the belt occurs.

FIG. 3A shows the jet directed in a direction opposite that of the direction of movement A of the belt. This is referred to as chiseling, and is described more fully below. FIG. 3B on the other hand shows the jet 22 directed in the same direction as the movement A of the belt. This is referred to as chasing. As described later, chasing is preferred for deep penetrative cleaning.

The belt surface is affected differently when the water jet is set to a chase angle (x axis vector of water jet is at a higher velocity and same direction as belt travel) verses a chisel angle (x axis vectors of both water jet and belt are in opposition). The water jet velocity determined by delivery pressure, orifice configuration, distance verses belt velocity is referred to in general as the dynamic velocity mode. The resultant velocity is compounded to the static setup angle to yield X vector and Y vector values. The belt travel velocity is always referenced as the X vector with a Y vector value of zero.

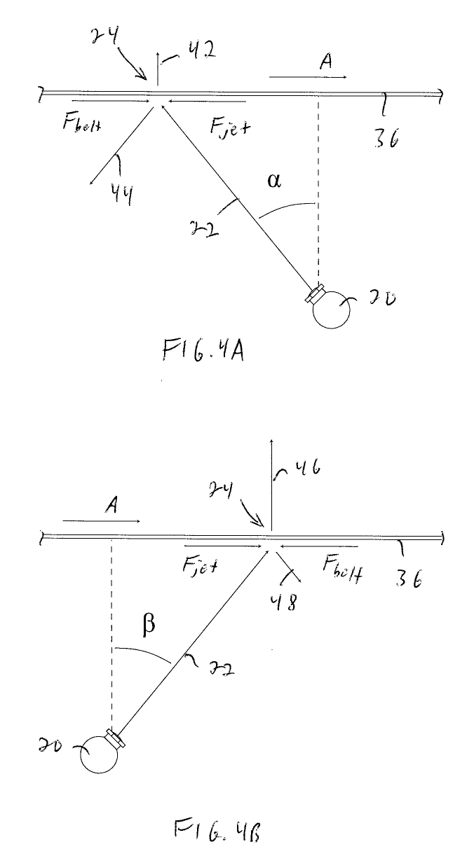

The shower water jet impingement angle (α) on the serpentine belt is typically installed statically (as a fixed relationship) and is employed in this configuration through the life cycle of the fabric belt. FIG. 4A shows the shower beam 20 in a chiseling orientation. During chiseling, shower beam 20 directs the cleaning fluid jet 22 through nozzles 21 toward oncoming belt at an angle α. The force of the jet 22 on the belt 36 at cleaning area 24 is meant to remove contaminants from the surface of belt so that the resulting reflected stream 44 carries away an optimal amount of surface contaminants. The force of the belt (F_{belt}) opposes the force component of the fluid jet 22 (Fⱼₑₜ) acting along the surface of the belt 36, creating a large disruptive force parallel to the surface of the belt 36. Because the angle α is chosen for optimized chisel cleaning, the amount of penetrating stream 42 moving perpendicular to the surface of belt 36 is small in comparison to the reflected stream 44.

In FIG. 4B, however, the shower beam 20 is directed in a chasing orientation where the cleaning fluid jet 22 is directed toward downstream belt at an angle β. The force of the jet 22 on the belt 36 at cleaning area 24 is meant to remove contaminants from the belt by penetrating the fabric, forcing contaminants through the thickness of the belt. In this orientation, the force component of the jet (Fⱼₑₜ) along the surface of the belt 36 is minimized, such that the force of the belt (F_{belt}) that opposes the force component of the jet (Fⱼₑₜ) does not result in significant lateral forces along the surface of belt 36. This can be accomplished by choosing an angle β such that the velocity component of the jet 22 in direction A is substantially the same as the velocity vector of the belt 36. This results in the majority of the force of the jet being directed through the belt, with the resulting penetrating stream 46 being optimized to carry away most of the contaminants, with the reflected stream 48 containing far fewer contaminants.

The angles α and β are factors of at least the speed of the belt and the fluid jet pressure. For example, in the chasing orientation, the proper impingement vector angle is calculated by the formula:

β=sin⁻¹[fpm/(\sqrt{2.15×psi}×465)]

For example, a wire/fabric velocity 2800 fpm, water jet pressure 300 psi yields a chasing angle of 16.88°.

Because the jet 22 contacts the belt head on, the angle α can be larger, as the component of the velocity vector of jet 22 directed through the belt 36 is not a primary contamination mover. This orientation also requires lower pressure, as the belt speed combines with the opposing jet velocity component to skive off contaminants efficiently.

Conversely, when in the chasing orientation, the jet 22 is directed at a comparatively smaller angle β so that a larger component of the velocity vector of jet 22 is in the direction perpendicular to the surface of the belt. Some amount of fluid is reflected from the surface, causing the fibers of the belt to be reoriented, which aids in exposing more contamination to the cleaning fluid jet 22.

Selecting a chiseling orientation versus a chasing orientation depends on multiple factors. The furnish materials used, the material and design of the belt, additives in furnish, and other manufacturing variables contribute to the deposition of contaminants on the belt, as well as a resultant choice of orientation.

A chasing cleaning orientation can use high pressure to force most contaminants through the belt. However, chiseling orientation may be preferable as it generally more efficient and less expensive to use, as it requires less water and does not wear belts out as quickly compared to chasing. Maintaining a shower head in a fixed static orientation, however, may lead to contamination memory where contaminants can be caught in the shadow of a cleaning spray and will not be readily removed.

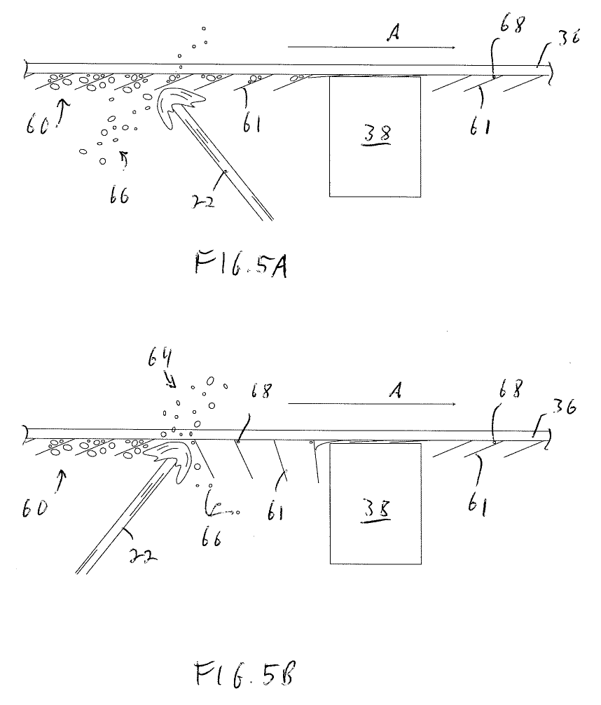

FIG. 5A shows a close-up of the cleaning process when the shower beam 22 is directing the cleaning fluid jet 22 in a chiseling orientation. In this orientation, contamination 60 caught in wicking fibers 61 is cleaned away, with a greater amount of reflected contamination 66 being released from the belt 36 compared to a small amount of penetrated contamination 64 going through the belt. In this configuration, the fibers 61 of the belt 36 stay flat against the belt, and are not significantly deformed as they go past the vacuum box 38. Because of this continuous cleaning in the fixed/static orientation, remaining contamination 68 may exist due to “contamination memory” as described above.

In FIG. 5B on the other hand, when met with a cleaning fluid jet 22 in the chasing orientation, contamination 60 is predominantly forced through the belt 36, with the penetrated contamination 64 being more prevalent than reflected contamination 66. When the jet vector impingement is setup at the chiseling angle the wicking fibers remain in a combed non-articulated state, compacted against the belt surface as the belt traverses across the vacuum boxes and through the press nip. Conversely, when the shower impingement angle is in the chasing impingement angle, the fibers are forced up, uncompacting, by the water jet 22 action on the belt surface. This reorientation results in a more complete removal of contamination, with relatively little remaining contamination 68 left on belt 36. The fibers 61, however, are pushed back down against the belt 36 as the belt 36 moves past the vacuum box 38. This continual reorientation of the fibers 61 leads to fatigue that wears the surface of the belt faster than when the fibers remain in a substantially combed orientation throughout the lifecycle of the belt 36.

It is therefore an object of the invention to combine the lower operating costs of cleaning using the chiseling orientation with the effective contamination removal of the chasing orientation. The present invention provides a means to get the benefit of both long belt life and deeper surface articulation cleaning the jet/belt surface impingement angle by rotation of the shower beam from one vector angle to another. This rotation would be implemented when prevalent contamination memory starts to affect paper machine performance and efficiency.

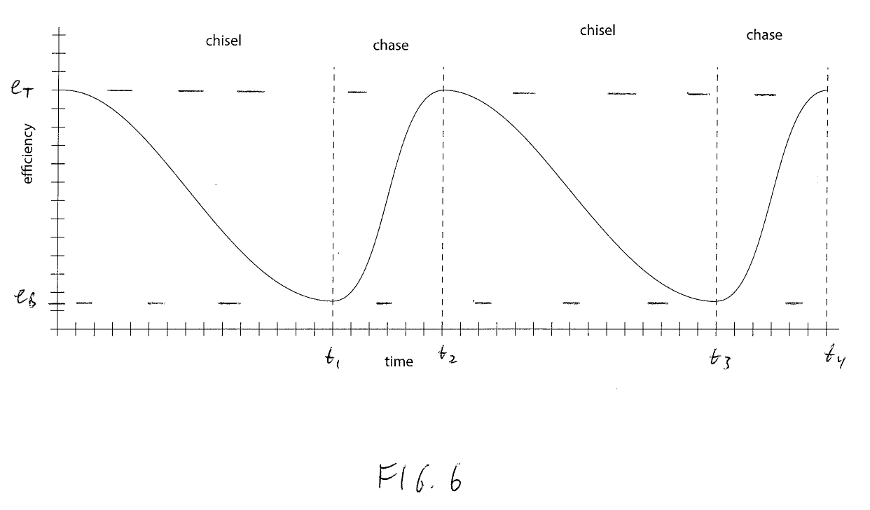

FIG. 6 shows a graph of the periodic cycling of the cleaning fluid jet 22 from a chisel angle to a chase angle. The paper making system 30 relies on sensors and algorithms (described hereinafter) to measure the dewatering efficiency of the belt and quality of the paper at various parts of the system 30. The system aims to keep operating efficiency and quality within an initial predetermined band of acceptability. This acceptable band is shown in the graph to have a top efficiency of e_{T} and a minimum efficiency of e_{B} (which reflect a combined dewatering efficiency and paper quality rating). While the system is preferably in the chiseling orientation to keep costs low, belts 36 of the system 30 will load up with contamination 60, reducing dewatering efficiency and paper quality over time.

When the system reaches the lowermost efficiency threshold e_{B}, the system initiates a conversion from a chiseling orientation to a chasing orientation. This initiation can be in the form of an alert to prompt a user to change the orientation, or can initiate a motor or other automatic method of altering the orientation. Once the system returns to the topmost efficiency rating e_{T}, the system again initiates a change of orientation from chasing to chiseling. As the cycle continues throughout the paper production process, the topmost efficiency may change to reduce the allowable operating band until such time as the switching between chiseling and chasing in and of itself becomes inefficient to the process, with the time between cycles becoming longer or shorter as required to remain within the acceptable efficiency band. At this point the belt can be changed out or remediated according to a different process.

Feed forward performance decrease(s) of the paper machine may be anticipated and acted on from active data from various sensors and algorithms monitored on the paper machine. These monitored signals/sensors will drive the need to change (in real-time) the jet/belt impingement angle by rotation of the shower beam. This articulation of the shower beam may be manual or automated, as further described herein. This articulation may be done on-the-fly without disruption of overall paper machine operations.

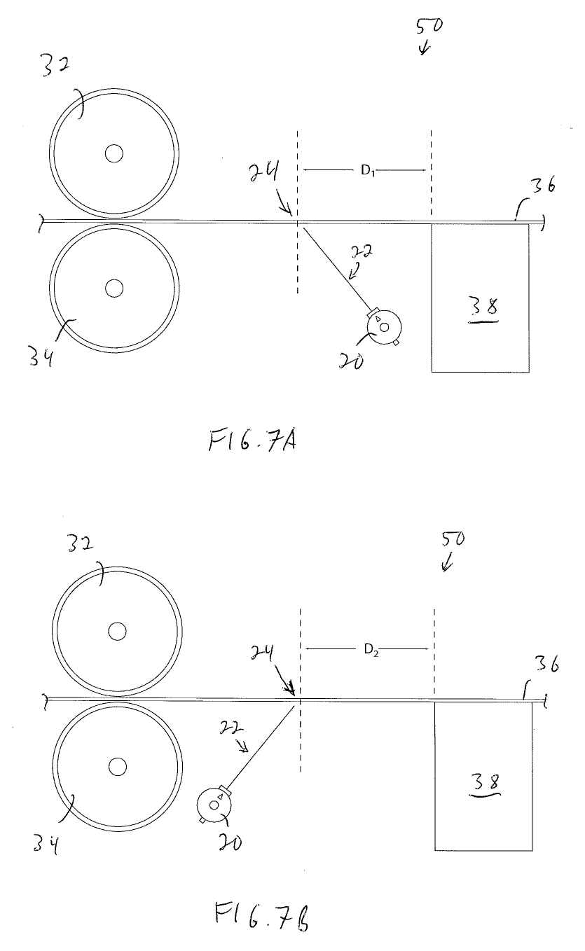

During the cycling process of changing between chiseling and chasing orientations, the dewatering of the belt may also be impacted by where in the process the contact point of the cleaning jet fluid 22 against belt 36 occurs. As shown as an example in FIGS. 7A and 7B, the cleaning area 24 is disposed between nip rollers 32/34 and vacuum box 38. Because the fluid jet 22 may impact the saturation of the belt 36 in different ways depending on the amount and pressure of cleaning fluid that travels through the belt, may be preferable to maintain a predefined distance D1/D2 between the cleaning area 24 and the vacuum box 38, for example, such that the vacuum box 38 can be adjusted to remove a desired mount of fluid from the belt 36.

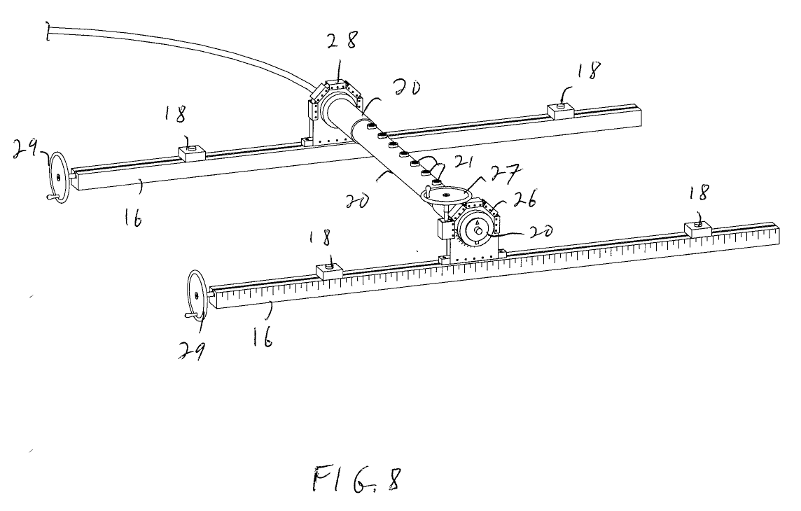

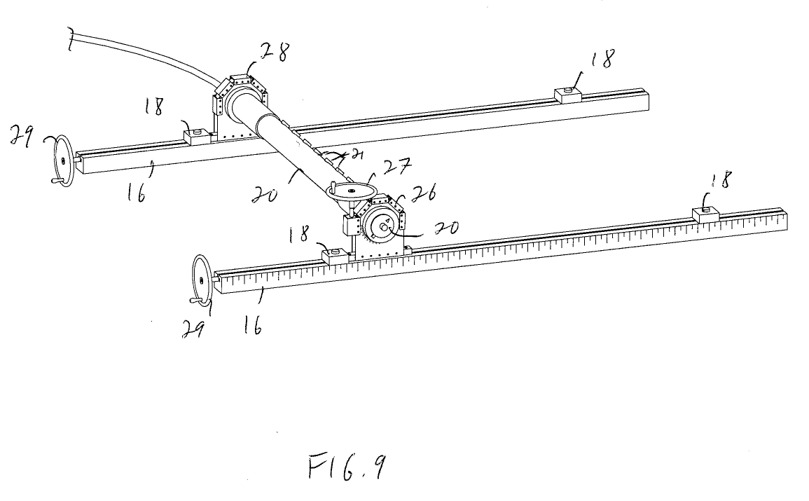

FIG. 8 shows the system of FIG. 2 with the shower beam 20 moved to a center portion of the rail movement distance range (between the stops 18 on the rails 16), and FIG. 9 shows the system with the shower beam 20 at an end of the rail movement distance range opposite that shown in FIG. 2. The movement of the actuators 27 and 29 may be manual or automatic (as discussed in more detail below), and movement of the actuators 27, 29 may be independent of one another or may be coupled together (as discussed in more detail below).

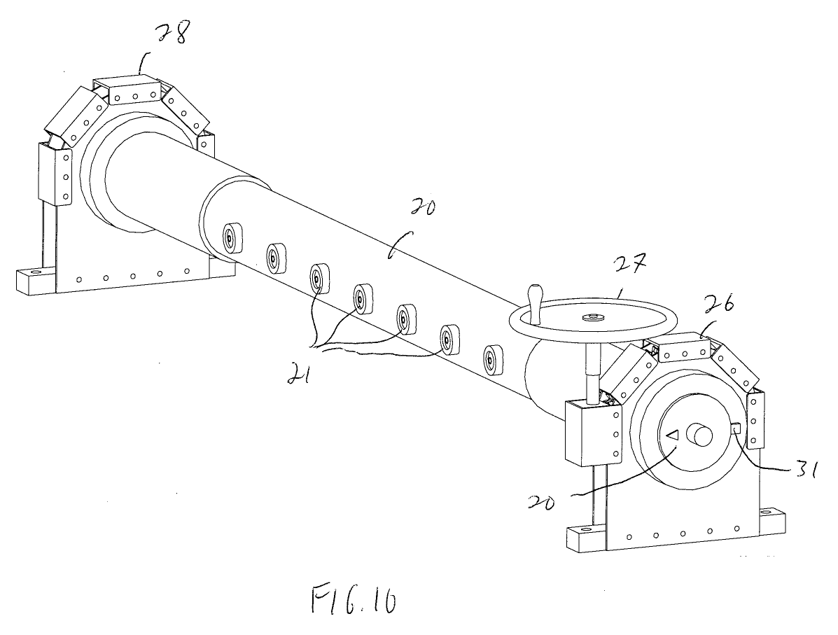

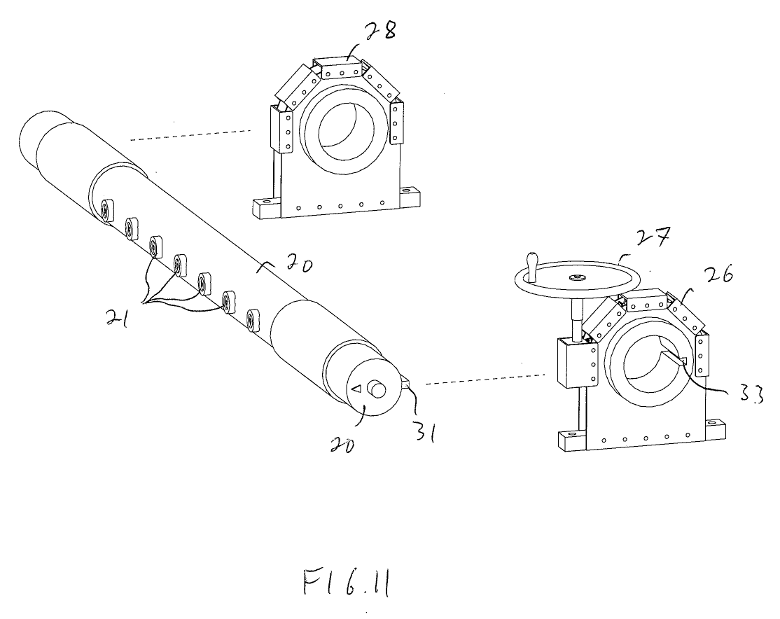

FIG. 10 shows a closer view of the nozzles 21 in the shower beam 20, and further shows that the shower beam 20 may include a key 31 that, as further shown in FIG. 11 (which shows an exploded view of the shower beam 20 and beam mounts 26, 28), the key 31 may be received by a slot 33 in the beam mount 28 to transfer actuation of the actuator 27 into rotation of the beam 20. In accordance with various embodiments, either one beam mount (26 as shown) may be actuated with the other beam mount (28) acting as a follower. In further embodiments, but beam mounts may be actuatable, again, either manually or automatically as discussed below.

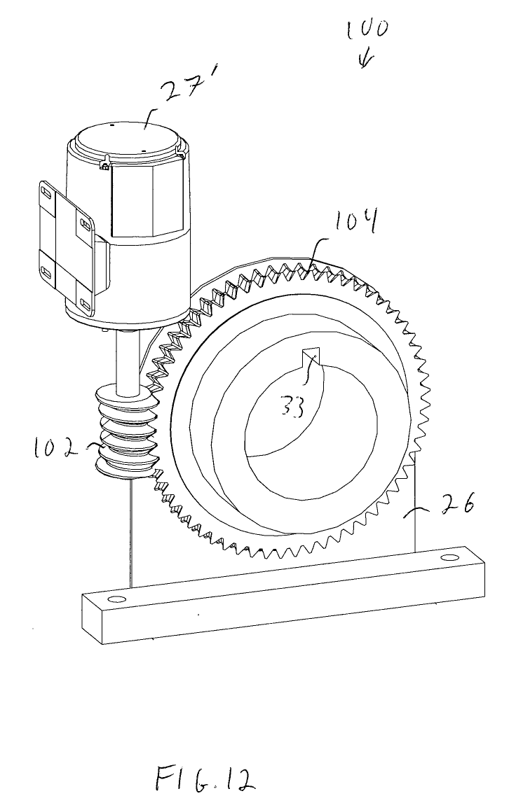

The gearing mechanism 100 to transfer rotation of the actuator into rotation of the beam is shown in FIG. 12 in which an automated actuator 27′ is used in place of the manual actuator 27 shown in FIG. 2. The gearing mechanism is the same, including a worm gear 102 attached to the actuator 27, 27′ that drives a worm wheel 104 attached to the shower beam 20.

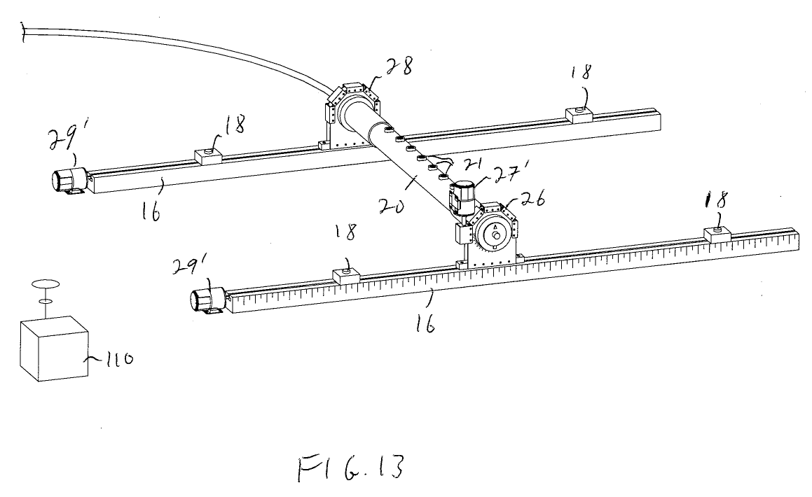

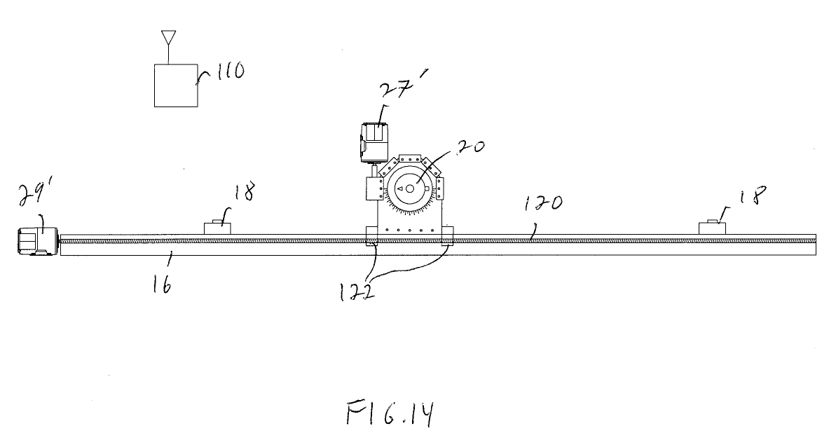

FIG. 13 shows a system similar to that of FIG. 8 including a shower beam 20 mounted in beam mounts 26, 28 that travel along rails 16 between stops 18. In the system of FIG. 13, the rotation of the beam 20 is controlled by automated actuator 27′ and movement of the beam mounts is achieved by actuation of the automated actuators 29′. The system may operate under the control (e.g., wirelessly) of one or more processing systems 110. With reference to FIG. 14, the system in particular may include a threaded drive rod 120 in each rail 16, and the beam mounts 26, 28 may include threaded collars 122 that move the mounts 26, 28 responsive to rotation of the threaded drive rods 120.

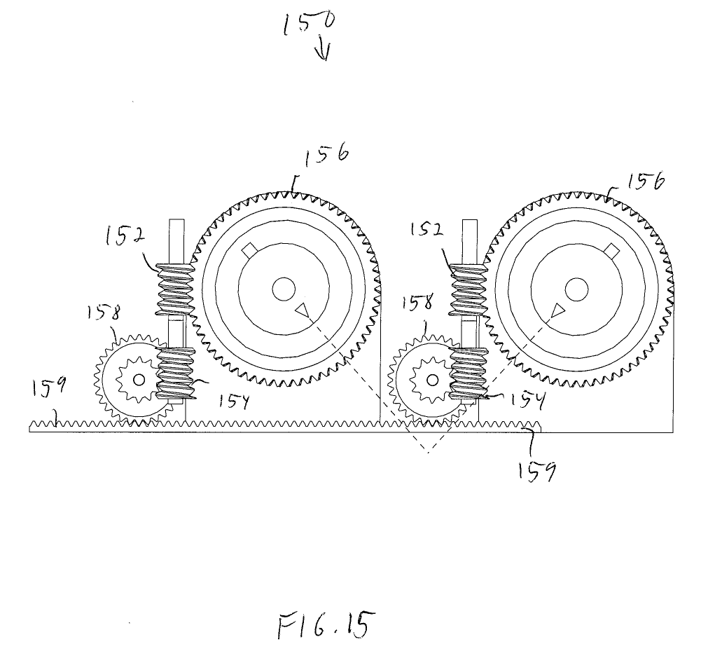

FIG. 15 shows an alternative drive mechanism 150 that includes a dual worm gear having two worm gear sections 152, 154. One worm gear section 152 drives a worm wheel 156 to rotate the shower beam, while the other worm gear section 154 drives a pinion gear 158 that engages a rack 159. FIG. 15 shows the drive mechanism 150 in two different positions on either side of an inflection point (normal to a belt surface) superimposed on one another. With such a drive mechanism 150, a single actuator (either manual or automated as discussed above) may both rotate the shower beam and move the beam mounts.

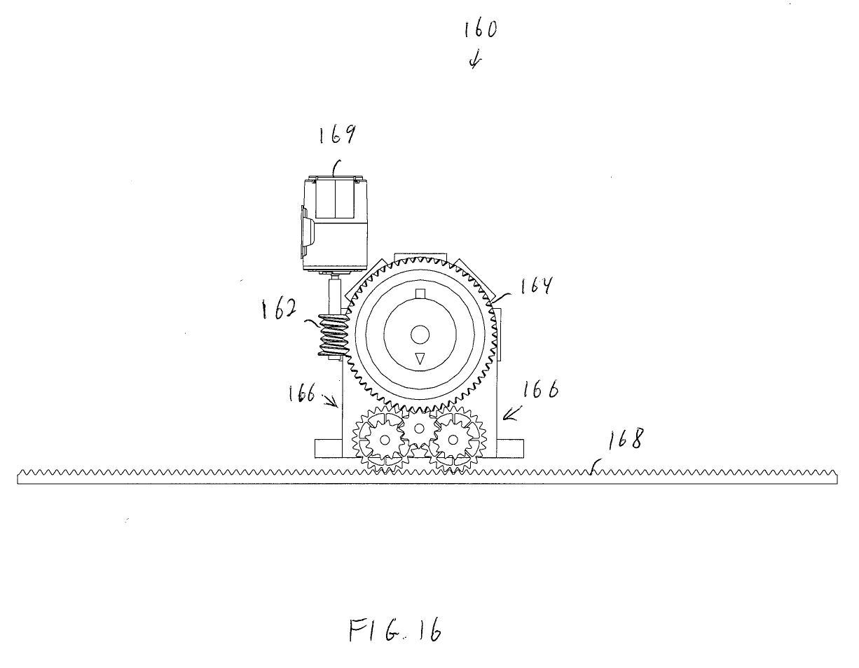

FIG. 16 shows a further alternative drive mechanism 160 that includes a worm gear 162 that drive a worm wheel 164 to rotate the shower beam. In the system 160 however, the worm wheel 164 is also used to drive a pinion gear mechanism 166 that engages rack 168 in the rails of a system of the present invention. Again, with such a drive mechanism 160, a single actuator 169 (either manual or automated as discussed above) may both rotate the shower beam and move the beam mounts.

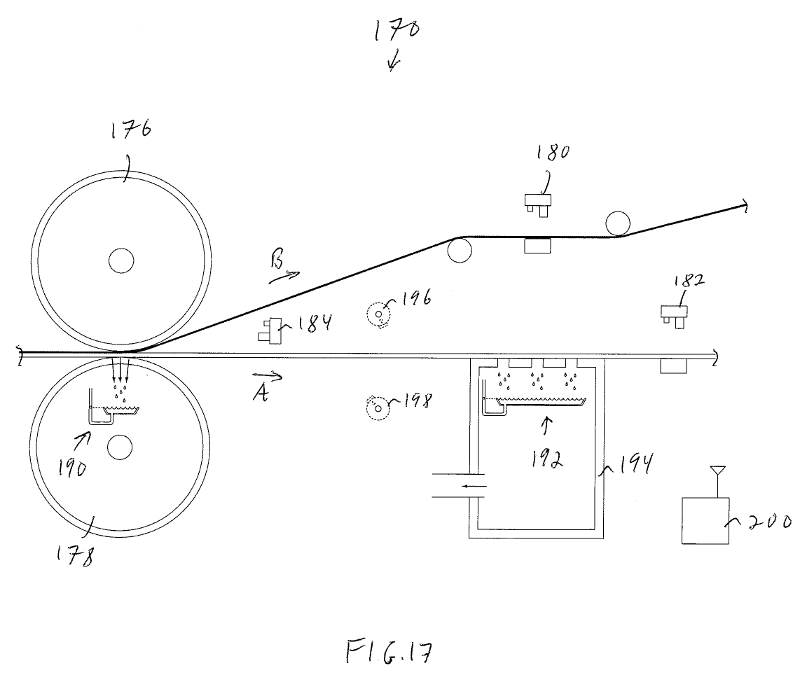

FIG. 17 shows a system 170 in accordance with a further embodiment of the present invention in which a belt 172 supports a paper 174 in a papermaking system. The belt 172 and paper 174 travel between rollers 176, 178, and are then separated as the belt moves in the direction generally shown at A and the paper moves in the direction generally shown at B. The system 170 may include one or more detection systems 180, 182, 184 that detect performance characteristics of the paper or the belt. Such performance characteristics may include the amount of contaminates, and this may be detected by a camera image capture of by reflection of an electromagnetic field through the paper or belt. Further, a detection system 184 may monitor the active separation of the paper from the belt (e.g., if inconsistent or not separating early enough such a staying together too long). Additionally, one of the rollers 178 may include provide an internal vacuum that draws cleaning fluid from the belt and paper, and further may include a fluid removal and measurement system 190 that detects the amount of fluid being removed. Similarly, the system 170 may include provide a vacuum and a fluid removal and measurement system 192 in an Uhle box 194. The system may monitor these performance characteristics, and adjust accordingly any of adjustable shower beams 196, 198 either above or below the belt 172 under the control (e.g., wirelessly) of one or more processing systems 200.

Those skilled in the art will appreciate that numerous modifications and variations may be made to the above disclosed embodiments without departing from the spirit and scope of the present invention.

What is claimed is:

1. A system for providing impingement of a fluid for fabric conditioning, said system comprising a fluid jet and a control mechanism for adjusting an impingement angle of the fluid jet onto a workpiece such that the angle may be adjusted through an angle that is perpendicular to the workpiece.

2. The system as claimed in claim 1, wherein the fluid is water.

3. The system as claimed in claim 2, wherein the workpiece is a belt in a paper making machine.

4. The system as claimed in claim 3, wherein the belt includes a paper web.

5. The system as claimed in claim 3, wherein the belt includes a wire for paper forming.

6. The system as claimed in claim 3, wherein the belt is provided in a drying section.

7. The system as claimed in claim 1, wherein the impingement angle is selected to provide a chasing application.

8. The system as claimed in claim 1, wherein the impingement angle is selected to provide a chiseling application.

9. A method of removing contaminants from a papermaking belt used for making a paper sheet, the method comprising the steps of:
feeding the belt in a first direction;
spraying the belt with a cleaning fluid directed at a first cleaning angle with respect to the belt;
monitoring performance characteristics of the belt; and
changing the cleaning angle from said first cleaning angle to a second cleaning angle responsive to the monitored performance characteristics.

10. The method as claimed in claim 9 wherein the performance characteristics include one or more of: belt absorption/desorption rate/amount; sheet surface smoothness; contamination transferred from the belt to the paper sheet; release point of the sheet from the belt (sheet stealing/sticking.

11. The method as claimed in claim 9, wherein the performance characteristics are monitored using optical sensors that identify surface characteristics of the paper sheet.

12. The method as claimed in claim 11, wherein the surface characteristics include smoothness/texture/impurities/imperfections.

13. The method of claim 9, wherein the performance characteristics are monitored using optical sensors that identify surface characteristics of the belt.

14. The method of claim 9, wherein the performance characteristics are monitored using flow sensors that measure the amount of fluid removed from the belt.

15. The method as claimed in claim 14, wherein the flow sensors measure the amount of fluid removed from the belt by a water removal system.

16. The method as claimed in claim 15, wherein the water removal system includes a perforated nip roller.

17. The method as claimed in claim 15, wherein the water removal system includes a vacuum box.

18. The method of claim 9, wherein the wherein the cleaning fluid is directed at the belt through at least one nozzle that is rotatable about a first axis, and the fluid is directed at the first cleaning angle when the nozzle is in a first position, and wherein the step of changing the cleaning angle includes rotating the at least one nozzle about said first axis from said first position to a second position.

19. The method of claim 18, wherein the cleaning fluid is directed through the at least one nozzle at a first cleaning pressure when the nozzle is at the first position and a second cleaning pressure when the nozzle is at the second position.

20. The method as claimed in claim 19, wherein the first pressure is different than the second pressure.

21. The method as claimed in claim 19, wherein the cleaning fluid has a velocity component in the first direction when the nozzle is in the first position, and a velocity component opposite the first direction when the at least one nozzle is in the second position.

22. The method as claimed in claim 21, wherein the first velocity is different than the second velocity.

23. Apparatus for cleaning a papermaking belt traveling through a papermaking system at a travel velocity, the apparatus comprising
an elongated shower pipe having at least one nozzle;
a supply conduit for providing a cleaning fluid to said at least one nozzle;
a first adjustment means coupled to said shower pipe for rotating said at least one nozzle about a first axis, and
monitoring means for monitoring performance characteristics of the belt.

24. The apparatus as claimed in claim 23, wherein the apparatus further includes a control means coupled to said first adjustment means to rotate the at least one nozzle to a desired angle in response to monitored performance characteristic.
